(19) United States
(12) Patent Application Publication
(10) Pub. No.: US 2010/0157317 A1
(43) Pub. Date: Jun. 24, 2010

(54) SYSTEM AND METHOD FOR MEASURING DIMENSIONS OF A CUTTING TOOL

(75) Inventor: WEI-DER TANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/346,795

(22) Filed: Dec. 30, 2008

(30) Foreign Application Priority Data
Dec. 19, 2008 (CN) 200810306398.6

(51) Int. Cl. G01B 11/02

(52) U.S. Cl. 356/634

(57) ABSTRACT

A testing system for testing dimensions of a cutting tool chosen by a cutting tool choosing device, includes a controller and an optical sensor. The controller includes a cutting tool changing module, a cutting tool control module, and a dimension calculating module. The cutting tool changing module is configured for controlling the cutting tool choosing device to move the cutting tool to a tip initial position above the optical sensor. The cutting tool control module is configured for controlling the cutting tool choosing device to move the cutting tool from the tip initial to the height of a lightbeam of the optical sensor, and moving the cutting tool to pass through the lightbeam of the optical sensor from side to side. The dimension calculating module is configured for receiving the electrical signals from the optical sensor and calculating dimensions of the cutting tool.

### BACKGROUND

1. Technical Field

The present disclosure relates to measuring systems and methods and, particularly, to a system and a method for measuring dimensions of a cutting tool.

2. Description of Related Art

In a computer numerical control (CNC) system, a cutting tool is a significant component used for machining metal workpieces. During a machining process, when a new cutting tool is chosen, dimensions, such as length and diameter of the new cutting tool should be measured to ensure precision of machining. However, measuring takes time and reduces productivity.

What is needed, therefore, is to provide a system and a method for measuring dimensions of a cutting tool to overcome the above described shortcomings.

### BRIEF DESCRIPTION OF THE DRAWINGS

FIG. 1 is a block diagram of an exemplary embodiment of a system for measuring dimensions of a cutting tool, together with a cutting tool storage and a cutting tool choosing device.

FIG. 2 is a schematic view showing the cutting tool choosing device of FIG. 1 clamping the cutting tool and is moved from an initial position above the optical sensor to a height of a lightbeam to touch the lightbeam.

FIG. 3 is a schematic view showing the cutting tool passing through the lightbeam from side to side.

FIG. 4 is a signal diagram generated by the optical sensor during the cutting tool moving process of FIGS. 2 and 3.

FIG. 5 is a flowchart of an exemplary embodiment of a method for measuring dimensions of a cutting tool for implementing the system of FIG. 1.

### DETAILED DESCRIPTION

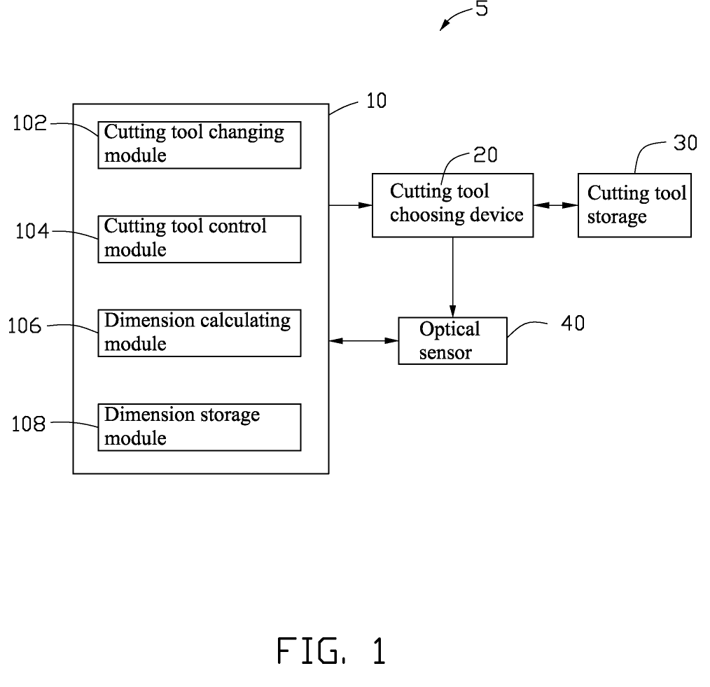

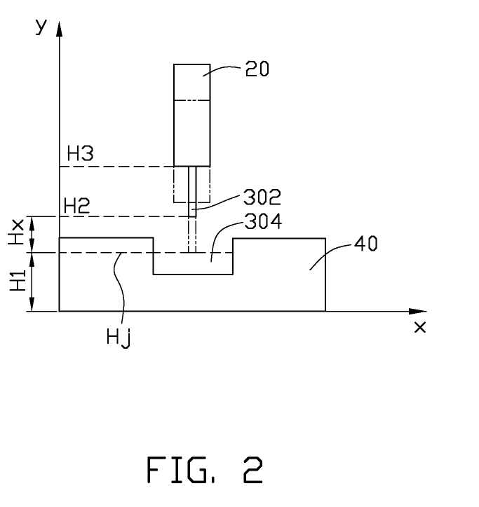

Referring to FIGS. 1 to 4, an exemplary embodiment of a system 5 for measuring dimensions of a cutting tool chosen by a cutting tool choosing device 20 from a cutting tool storage 30 of a computer numerical control (CNC) system includes a controller 10 and an optical sensor 40. The controller 10 includes a cutting tool changing module 102, a cutting tool control module 104, a dimension calculating module 106, and a dimension storage module 108.

The cutting tool choosing device 20 is configured for choosing and clamping cutting tools under the control of the controller 10.

The cutting tool storage 30 is configured for storing a number of cutting tools. Each cutting tool has a serial number, primary dimensions, such as length, and location coordinates stored in the cutting tool storage 30. Therefore, each cutting tool can be chosen according to the serial numbers, primary dimensions, and location coordinates from the cutting tool storage 30.

The optical sensor 40 may be a non-contact optical sensor in one embodiment. The optical sensor 40 defines a slot 304. A light source of the optical sensor 40 emits a lightbeam Hj in the slot 304. The optical signal is converted into an electrical signal by the optical sensor 40, and then the electrical signal is sent to the controller 10. In one embodiment, when the cutting tool is not blocking or partially blocking the lightbeam Hj, the optical sensor 40 sends a low level electrical signal, such as 0V, to the controller 10. When the cutting tool is in the path of the lightbeam Hj, the optical sensor 40 sends a high level electrical signal, such as 5V, to the controller 10.

The controller 10 is configured for measuring dimensions, such as the length, diameter, or deviation value of the cutting tool, according to the electrical signal. The deviation value of the cutting tool is a value of the rotating cutting tool deviating from a desired position at the bottom region of the cutting tool because of vibration.

The cutting tool changing module 102 is configured for controlling the cutting tool choosing device 20 to choose a cutting tool (such as the cutting tool 302) from the cutting tool storage 30, according to one or more of preset serial numbers, primary dimensions, and location coordinates, moving the cutting tool 302 to a tip initial position H2 above the optical sensor 40, and adjusting a spindle of the cutting tool choosing device 20 to a preset speed. The cutting tool 302 then rotates at the preset speed.

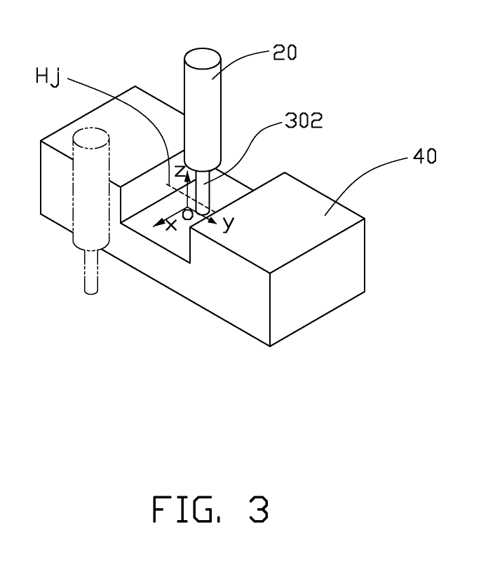

The cutting tool control module 104 is configured for controlling the cutting tool choosing device 20 to move the cutting tool 302 from the tip initial position H2 to the height of the lightbeam Hj to touch the lightbeam Hj, and to move the cutting tool 302 to pass through the lightbeam Hj from side to side, such as ‘ox’ direction as shown in FIG. 3.

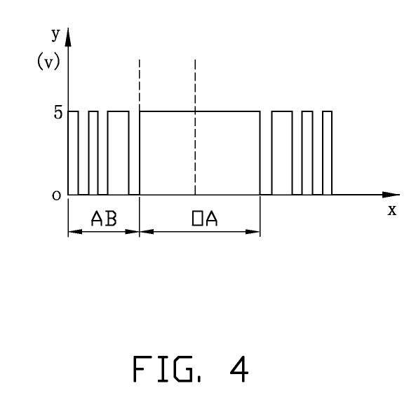

The dimension calculating module 106 is configured for receiving the electrical signals from the optical sensor 40, for calculating dimensions, such as length, diameter, and deviation value of the cutting tool 302, according to changes in electrical signal levels, and for sending the dimensions to the dimension storage module 108. The length of the cutting tool 302 is equal to a bottom position H3 of the cutting tool choosing device 20 minus the tip initial position H2 of the cutting tool 302. The tip initial position H2 is equal to the distance Hx the cutting tool 302 must move to touch the lightbeam Hj from the tip initial position H2 plus the height H1 of the lightbeam Hj of the optical sensor 40, that is, Hx+H1, where H1, H3, and a falling speed of the cutting tool 302 are pre-stored in the dimension calculating module 106. For instance, if H1=1.9 m, H3=2.5 m, the falling speed of the cutting tool 302 is 5 m/s, the cutting tool 302 takes 0.02 s to touch the lightbeam Hj of the optical sensor 40, the moving distance Hx of the cutting tool 302 is 0.02*5=0.1 m, the tip initial position H2=1.9+0.1=2 m, the length of the cutting tool 302 is H3−H2=0.5 m. The working principle of the optical sensor 40 is as follows: when the lightbeam Hj of the optical sensor 40 is blocked, the optical sensor 40 outputs a high level electrical signal, such as 5V. When the lightbeam Hj of the optical sensor 40 is not blocked, the optical sensor 40 outputs a low level electrical signal, such as 0V. Thus, when the rotating cutting tool 302 touches the lightbeam Hj in an unstable manner because of shaking, the optical sensor 40 could send both high and low level electrical signals, when the rotating cutting tool 302 is in the path of the lightbeam Hj, the optical sensor 40 sends a high level electrical signal, then as the rotating cutting tool 302 moves out of the path of the lightbeam Hj and is only partially in the path of the lightbeam, the optical sensor 40 sends both high and low level electrical signals as shown in FIG. 4. The diameter of the cutting tool 302 is the high electrical signal time OA multiplied by a moving speed of the cutting tool 302 when passing through the lightbeam Hj. The deviation value of the cutting tool 302 is high and low level electrical signal time AB multiplied by the moving speed of the cutting tool 302 when passing through the lightbeam Hj.

The dimension storage module 108 is configured for receiving and storing the dimensions, such as the length, the diameter, or the deviation value of the cutting tool 302.

In other embodiments, if the dimensions of the cutting tool 302 need not to be stored, the storage module 108 can be omitted.

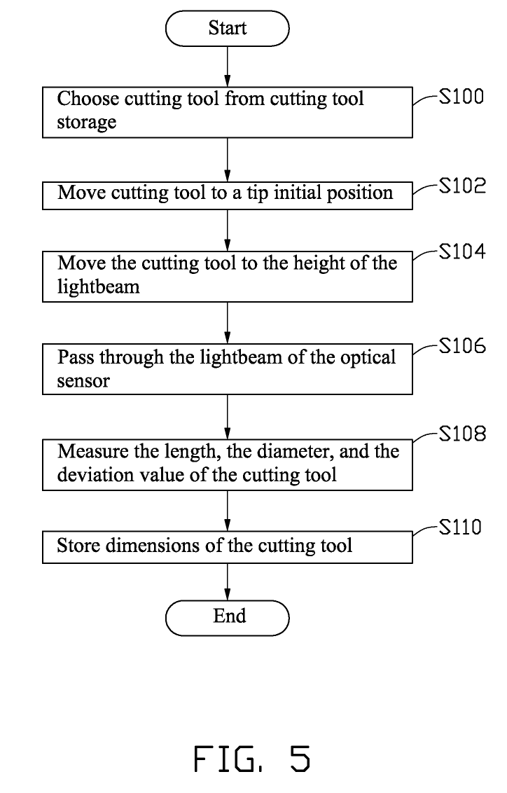

Referring to FIG. 5, an exemplary embodiment of a method for measuring dimensions of a cutting tool for implementing the above mentioned system includes the following steps.

In step S100, the cutting tool changing module 102 controls the cutting tool choosing device 20 to choose a cutting tool (such as the cutting tool 302) from the cutting tool storage 30, according to preset serial numbers, primary dimensions, or location coordinates.

In step S102, the cutting tool changing module 102 controls the cutting tool choosing device 20 to move the cutting tool 302 to a tip initial position above the optical sensor 40, and adjusting a spindle of the cutting tool choosing device 20 to the preset speed to make the cutting tool 302 rotate at the preset speed.

In step S104, the cutting tool control module 104 controls the cutting tool choosing device 20 to move the cutting tool 302 from the tip initial position H2 to the height of the lightbeam Hj to touch the lightbeam Hj.

In step S106, the cutting tool control module 104 controls the cutting tool choosing device 20 to move the cutting tool 302 to pass through the lightbeam Hj from side to side, such as ‘ox’ direction as shown in FIG. 3.

In step S108, the dimension calculating module 106 receives the electrical signals from the optical sensor 40, calculates dimensions, such as a length, a diameter, or a deviation value of the cutting tool 302, according to changes in signal levels, and sends the dimensions to the dimension storage module 108. The length of the cutting tool 302 is equal to a bottom position H3 of the cutting tool choosing device 20 minus the tip initial position H2 of the cutting tool 302, that is, H3−H2. The tip initial position H2 is equal to the moving distance Hx plus the height H1 of the lightbeam Hj of the optical sensor 40, that is, Hx+H1. The diameter of the cutting tool 302 is the high level signal time OA multiplied by the moving speed of the cutting tool 302 when passing through the lightbeam Hj. The deviation value of the cutting tool 302 is the high and low level signal time AB multiplied by the moving speed of the cutting tool 302 when passing in and out of the lightbeam Hj.

In step S110, the dimension storage module 108 receives and stores the dimensions.

In other embodiments, if the dimensions of the cutting tool 302 need not to be stored, step S110 can be omitted.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A system for measuring dimensions of a cutting tool chosen by a cutting tool choosing device of a computer numerical control (CNC) system, the system comprising:
an optical sensor comprising a lightbeam formed by light and configured for converting optical signals into electrical signals; and
a controller comprising:
a cutting tool changing module configured for controlling the cutting tool choosing device to move the cutting tool to a tip initial position above the optical sensor, and adjusting a spindle of the cutting tool choosing device to a preset speed;
a cutting tool control module configured for controlling the cutting tool choosing device to move the cutting tool from the tip initial position to a height of the lightbeam to touch the lightbeam, and for moving the cutting tool to pass through the lightbeam from side to side; and
a dimension calculating module configured for receiving the electrical signals from the optical sensor, for calculating dimensions of the cutting tool according to changes in electrical signal levels.

2. The system of claim 1, further comprising a dimension storage module configured for receiving and storing the dimensions of the cutting tool.

3. The system of claim 2, wherein dimensions of the cutting tool comprises a length, a diameter, and a deviation value, the length of the cutting tool is equal to a bottom position of the cutting tool choosing device minus the tip initial position of the cutting tool, the tip initial position is equal to a moving distance plus a height of the lightbeam of the optical sensor, the diameter of the cutting tool is a high level signal time multiplied by a moving speed of the cutting tool when passing through the lightbeam, the deviation value of the cutting tool is a high and low level signal time multiplied by the moving speed of the cutting tool when passing in and out of the lightbeam.

4. The system of claim 1, wherein the optical sensor is a non-contact optical sensor and defines a slot, the lightbeam is located in the slot.

5. The system of claim 1, wherein the cutting tool changing module further configured for controlling the cutting tool choosing device to choose the cutting tool according to serial numbers, primary dimensions, or location coordinates from a cutting tool storage.

6. A method for measuring dimensions of a cutting tool chosen by a cutting tool choosing device of a computer numerical control (CNC) system, the method comprising:
providing an optical sensor for sensing the cutting tool to send electrical signals, wherein the optical sensor comprises a lightbeam formed by light;
controlling the cutting tool choosing device to move the cutting tool to a tip initial position above the optical sensor, and adjusting a spindle of the cutting tool choosing device to a preset speed;
controlling the cutting tool choosing device to move the cutting tool from the tip initial position of the cutting tool to the height of the lightbeam, and to move the cutting tool to pass through the lightbeam from side to side;
receiving electrical signals from the optical sensor to calculate dimensions of the cutting tool.

7. The method of claim 6, further comprising receiving and storing dimensions of the cutting tool.

8. The method of claim 6, wherein dimensions of the cutting tool comprises length, diameter, and deviation value, the length of the cutting tool is equal to a bottom position of the cutting tool choosing device minus the tip initial position of the cutting tool, the tip initial position is equal to a moving distance plus a height of the lightbeam of the optical sensor, the diameter of the cutting tool is a high level signal time multiplied by a moving speed of the cutting tool when passing through the lightbeam, the deviation value of the cutting tool is a high and low level signal time multiplied by the moving speed of the cutting tool when passing in and out of the lightbeam.

9. The method of claim 6, wherein if the lightbeam of the optical sensor is blocked, the optical sensor outputs high level electrical signals, if the lightbeam of the optical sensor is not blocked, the optical sensor outputs low level electrical signals.

10. The method of claim 9, wherein the high level electrical signal is 5V, and the low level electrical signal is 0V.

11. The method of claim 6, wherein the optical sensor is a non-contact optical sensor and defines a slot, the lightbeam is located in the slot.

12. The method of claim 6, further comprising controlling the cutting tool choosing device to choose the cutting tool according to serial numbers, primary dimensions or location coordinates from a cutting tool storage.
